(19) United States
(12) Patent Application Publication
(10) Pub. No.: US 2015/0285322 A1
(43) Pub. Date: Oct. 8, 2015

(54) Brake Disk

(71) Applicant: SAF-HOLLAND GMBH, Bessenbach (DE)

(72) Inventors: Stefan Wallmeier, Goldbach (DE); Michael Roos, Marktheidenfeld (DE)

(21) Appl. No.: 14/431,923

(22) PCT Filed: Oct. 18, 2013
(86) PCT No.: PCT/EP2013/071841

§ 371 Date: Mar. 27, 2015

(30) Foreign Application Priority Data
Oct. 30, 2012 (DE) 102012219840.7

(51) Int. Cl. F16D 65/12; B22D 19/00

(52) U.S. Cl. CPC F16D 65/125; F16D 65/12; F16D 65/128; B22D 19/00; F16D 2065/1344

(57) ABSTRACT

Disclosed is a brake disk, in particular for a commercial vehicle, comprising two friction rings which are arranged substantially parallel to each other, and at least one connector piece, the friction rings each having a friction surface, which each define a plane, the at least one connector piece connecting the two friction rings to each other such that an intermediate chamber is formed between the planes of the friction rings, the brake disk having at least one additional element that is arranged inside the intermediate chamber, the additional element being formed from a metal baser than the at least one connector piece and the friction rings.

### BACKGROUND OF THE INVENTION

The present invention relates to a brake disk, in particular for a commercial vehicle or utility vehicle, additional elements, in particular corrosion-inhibiting elements, as well as methods of manufacturing a brake disk, in particular for a commercial vehicle.

Brake disk, in particular for commercial vehicles, are well-known in the prior art. Due to the high loads, as a rule vented brake disk are used, consisting of two friction rings connected to one another by means of connecting webs. Air ducts cooling the brake disk are thus created between the two friction rings. Apart from the very high mechanical loads as well as the high temperature loads, brake disks are also subject to highly different weather conditions. In particular in the case of vented brake disks, there is corrosion inside the brake disk, mainly at the connecting webs, due to the influence of humidity and salt. In case the brake disk is exposed to said media over a longer period of time, in the worst case the safety-related component brake disk will corrode through, leading to a malfunctioning or failure of the brake disk.

Thus, the object underlying the present invention is to provide a brake disk, in particular for a commercial vehicle, additional elements, in particular corrosion-inhibiting elements, as well as methods of manufacturing a brake disk, in particular for a commercial vehicle, protecting the brake disk from corrosion damage, in particular at the connecting webs.

### SUMMARY OF THE INVENTION

According to the invention, a brake disk, in particular for a commercial vehicle, comprises two friction rings, which are arranged substantially parallel to each other, and at least one connector piece or connecting web, the friction rings each having a friction surface, which each define or span a plane, the at least one connecting web connecting the two friction rings to each other such that an intermediate chamber is formed between the planes of the friction rings, the brake disk having at least one additional element, which is arranged inside the intermediate chamber, the additional element being formed from a material baser than the at least one connecting web and the friction rings. Expediently, the friction rings are concentrically arranged. Preferably, this results in a concentric arrangement of the respective friction surfaces as well. The friction rings or the friction surfaces are preferably arranged concentrically about a common axis of rotation. The planes of the friction surfaces lie substantially perpendicular on the common axis of rotation. Consequently, also the intermediate chamber lies substantially perpendicular relative to the axis of rotation. The intermediate chamber is not to be understood as a component or the like, but only relates to an area, or, in the three-dimensional space, a volume, within which the at least one additional element may be arranged. To put it differently, the intermediate chamber describes a disk oriented perpendicular and concentric relative to the axis of rotation and having a thickness, which is dimensioned by the distance between the two planes of the friction surfaces. The intermediate chamber may also have a smaller thickness, for example in case it extends only from one friction ring to the next, but does not any more include the frictions rings themselves. The intermediate chamber also may not have the form of a closed “disk”, but, for example, substantially centrally may have a “hole” so to say. This means that the intermediate chamber advantageously extends only within the two friction surfaces or only between the two friction rings and so to say excludes the space in the center, in which the connecting adapter, for example, is located. Expediently, the arrangement of the additional element within the intermediate chamber can be freely chosen, as long as the principle of corrosion prevention, which will be explained later on, is applicable. “Applicable” means that there should be an electroconductive connection, e.g. between the additional element and the material to be protected. Apart from the friction rings, the brake disks of the type in question as a rule preferably have a connecting adapter allowing for an indirect and/or direct connection between the friction rings and the wheel hub or the like. The connecting adapter is connected to at least one friction ring preferably in a form-fitting and/or in a force-fitting manner. A single-piece embodiment may also be preferred, wherein the connecting adapter and the friction rings form one component. Thus, the friction rings fulfill the actual function of the brake disk, since thanks to them the actual brake force builds up in that respective brake pads are applied so that the vehicle is slowed down. The connecting adapter in turn is provided in order to connect the friction rings to the wheel hub etc. and, thus, so to say to finally transmit the braking torque to the rotating wheel. In preferred embodiments, the friction ring is cast onto the connecting adapter in a manner such that the friction ring or friction rings may expand radially, thus avoiding an opening up or expansion or widening of the friction rings (when the latter are subject to said heavy temperature fluctuations, for example). In further preferred embodiments, between the friction ring and the connecting adapter, there are arranged additional connecting elements, onto which the friction ring and the connecting adapter are cast. As a matter of course, also the connecting adapter is arranged concentrically relative to the axis of rotation. The connecting adapter is also arranged in the intermediate chamber and, thus is suitable for arranging at least one additional element. The same applies to the connecting elements. Preferably, a plurality of connecting webs are arranged between the friction rings. Said connecting webs are arranged and adapted such that a system of flow channels or air ducts is formed within the friction rings or between the friction rings. Preferably, the friction ring consists of a cast metal, preferably a high-temperature disk material. Preferably, the connecting webs are made from the same material as the frictions rings. Preferably, thus, the connecting webs and the friction rings form one component, which is preferably manufactured by a primary shaping method, in particular a casting method. Preferably, the additional element serves to protect the friction rings, and in particular the connecting webs from corrosion. Advantageously, the additional element is formed from a material baser than the friction rings and/or the at least one connecting web or the plurality of connecting webs. Thus, the additional element expediently serves as a sacrificial anode. Here, the additional element or the additional element(s) form(s) part of the brake disk so to say, when it/they is/are inserted into the brake disk already during the manufacturing process of the brake disk. The arrangement of the additional element is thus part of the manufacturing process of the brake disk. As a matter of course, the arrangement of the additional element also may form part of the manufacture of the friction ring(s) and/or of the connecting adapter and/or of the at least one connecting web and/or of another component of the brake disk. Alternatively preferably, the arrangement of the additional element is not a part or step of the manufacturing method of the brake disk and of the components thereof. The at least one additional element may then advantageously be attached to the (already existing) brake disk in a form-fitting and/or force-fitting manner and as such may at any time be easily replaced or exchanged. Furthermore, the additional element is preferably formed single-piece. Alternatively, however, also a multi-piece embodiment may be of advantage. Here, one variant may also be formed such that a part of the additional element is cast into the brake disk, for example, wherein a second part of the additional element is arranged in the cast-in part in a form-fitting and/or force-fitting manner and is replaceable. In particular with regard to the thermal loads on the brake disk, there is an advantage in applying or attaching at least one additional element compared to merely coating the disk with an anti-corrosive coating, for example. In particular brittle coatings having a substantially greater or smaller thermal expansion than a base material such as the high-temperature disk material of the brake disk, get cracks or completely detach from the base material of the brake disk when the brake disk expands. Then, there may be crevice corrosion, in particular concentrated at the cracks. Since the additional element need not necessarily be attached over the entire surface, the problem described does not present itself to that degree. During the corrosion process in question, the metal ions of the baser material enter into solution (dissolve) at the additional element and electrons flow towards the material of the brake disk, where the reduction of the protons dissolved in water takes place. In this active corrosion prevention, the corrosion of the nobler brake disk material is prevented or at least greatly reduced. In preferred embodiments, the material used for the additional element is manganese or zinc, for example. However, any material may be used for the additional element, as long as it can be regarded as being a baser material in relation to the material(s) of the connecting webs and the friction ring(s). Here, the terms “noble” and “base” are defined such that a material is all the more noble the more positive its standard potential is. The baser material has a high capability of electron delivery or oxidation in aqueous environment, wherein said characteristic can be taken from the known electrochemical series. Understandably, a material is particularly well suited as a sacrificial anode, which material as a redox pair with the material of the brake disk (i.e. the friction rings, connecting webs etc.) has a particularly high difference of the standard potentials. Preferably, the standard potential between the additional element and/or the at least one connecting web and/or the at least one friction ring is about 0.1 to 1.1 V, particularly preferably about 1.1. to 3.3. V. Depending on the material pair, also higher values are indeed desired. Expediently, the additional element may be introduced by many different procedures and in any form, wherein advantageously it should be in the proximity of the connecting webs. Generally speaking, the additional element advantageously may be arranged in the proximity of the component, which should particularly well be protected from corrosion. As a matter of course, not all additional elements need to be made from the identical material. Preferably, the material selection for the additional element may additionally be dependent on the positioning thereof. Here, the density of the material and, thus, the mass of the additional element is decisive. Expediently, the additional element arranged closer to the axis of rotation has a greater density than the additional element, which is further away (when seen radially). Finally, it is about the mass, which results from the density and the volume so that preferably the additional element arranged closer to the axis of rotation has a larger mass than the one, which is arranged further away. The centrifugal forces may thus be reduced. Advantageously, the additional element is arranged such that the form fit and/or force fit with the brake disk may be increased with the help of the centrifugal forces. As a matter of course, the features of the invention also come to bear or are applicable for a brake disk having no connecting webs, because it is not a vented brake disk, for example. However, such a brake disk would possibly have only one friction ring and the focus would not be to protect the connecting webs from corrosion. In addition, there is no limitation regarding the manufacturing method of the brake disk. Thus, it is not obligatory that the brake disk is cast, for example.

Advantageously, the additional element has an arrangement area, by means of which it is or can be fixed to the connecting web and/or to at least one friction ring. Advantageously, the arrangement of the additional element is releasable, advantageously for replacement within a predetermined maintenance interval. Preferably, the arrangement area of the additional element is that area, with which it is in contact with the brake disk. Here, it is irrelevant whether the additional element is formed as a solid body or as a hollow body. In a preferred embodiment of the additional element, the additional element is formed as a substantially cylindrical hollow body, for example, which has the arrangement area as an inner surface at least in a certain area. The thus formed additional element is thus preferably arranged about a connecting web. In this variant, the connecting web is preferably cast-in or at least partially cast into the additional element. Alternatively preferably, the additional element, which is at least in a certain area formed cylindrically and as a hollow body, circumferentially is not formed with a continuous surface, but has a slit and/or an opening, for example, by means of which it can for example be clipped to the connecting web. Alternatively preferably, the arrangement area may also be formed as a hook or the like, which allows for a force fit and/or form fit with the connecting web, preferably also with several connecting webs. Thus, the additional element advantageously has at least one arrangement area. Preferably, the additional element has several arrangement areas, by means of which it can be arranged accordingly at several connecting webs. Also preferably, the arrangement area of the additional element does not exactly have a special geometry. To this end, advantageously, in the brake disk, i.e. in one friction ring or also in both friction rings or in the respective connecting web, in which the additional element is to be arranged, a receptacle is provided, in the form of an opening, for example, such as a slit or a bore, in which the additional element can then be arranged in a form-fitting and/or force-fitting manner. Preferably, the arrangement is then made by means of a press fit or interference fit, which is adapted to take into account temperature distortions occurring during the use of the brake disk so that a thus arranged additional element will not fall out. Preferably, the parallel arrangement of the friction rings may also be used to arrange therebetween an additional element preferably in a force-fitting manner, by clamping it, for example. Here, the additional element may preferably be designed in its central section or effective area such that the latter is at first weakened when there is corrosion, whereby the clamping effect gets lost in the course of time and the additional element simply falls down. Here, the parts of the additional element, which fall down, expediently need to be dimensioned such that they will exceed neither the size nor the weight of small stones, for example. Preferably, the parts have a maximum extension of up to 10 mm, particularly preferably of up to 5 mm. The weight is preferably less than 10 g, particularly preferably less than 5 g. When there is an inspection, it can be easily controlled by means of a sight check whether possibly new additional elements need to be introduced. The arrangement area is always there to provide a contact with the material to be protected, in this case with the friction ring, and in particular with the connecting webs. As a matter of course, the contact may also be made indirectly by using or applying a further element. Thus, it is not necessarily required that the additional element or the arrangement area thereof is in direct contact with the friction rings or the connecting webs. It is decisive that the metal to be protected, in this case the friction rings and the connecting webs, are electroconductively connected to the additional element(s). It has to be ensured that electrons may flow in the direction of the metal to be protected. Thus, it is ensured that it is not the metal to be protected but the baser material of the additional element that gives off its electrons, is oxidized and goes into solution. In an alternatively preferred embodiment, the additional element may also be formed as a disk-shaped element, which is arranged concentrically within the friction rings. The arrangement area is then formed circumferentially so to say.

Expediently, the additional element has an effective area, which can be weakened by corrosion such that the arrangement of the additional element can be released or detached from the brake disk by corrosion of the effective area. Irrespective of whether the additional element can be released, it always has an effective area. When the additional element is made from one and the same material and said material is baser in comparison to the material of the brake disk, then the entire additional element is the effective area. Thus, also the arrangement area serves as effective area. The difference is solely due to the fact that that arrangement area is at least partially in contact with the brake disk. Advantageously, also the additional element is made from two materials. For example, the effective area is made from a material baser than the arrangement area and the latter from a material baser than the brake disk or the components thereof such as the friction rings and the connecting webs etc. Thus, the corrosion can be apportioned and directed even more selectively to the desired components. For example, it can thus be ensured that an arrangement area, which is hook-shaped, for example, remains permanently arranged, while the effective area is selectively weakened. Such a “used-up” additional element cannot be ejected during travel due to the centrifugal forces acting during travel. Rather, replacement during the next stop at the garage is easy and inexpensive. Thus, advantageously, a suitable material selection makes it possible to avoid that an additional element, which has already been weakened in the area of the arrangement area, due to the centrifugal forces acting in the brake disk, flies away, for example. Preferably, it should be taken care to design the arrangement area as thick as is possible and with a smaller surface. The effective area should have a very small wall thickness and a large surface so that preferably said area is corroded. When there is a failure due to too much corrosion of the additional element, the latter will fall towards the inside out of the brake disk, so that failure is thus prevented during travel, in which the element is accelerated towards the outside by the radial forces. Further preferably, the additional element is multi-piece, e.g. three-piece, wherein a central part takes over the function of the effective area and the other parts take over the function of the arrangement areas. The various parts preferably can be connected in a form-fitting and/or force-fitting manner, by means of threads or by being capable of being fit or nested one into the other, for example.

Advantageously, the additional element is formed as a ring running about an axis of rotation of the brake disk at least in a certain area. The axis of rotation is the above-mentioned axis of rotation, in relation to which the friction ring or the friction rings, i.e. so to say the brake disk, is/are concentrically arranged. A ring, which is arranged in this way and which runs circumferentially at least in a certain area is thus advantageously arranged also parallelly to the friction rings or to the friction surfaces within the intermediate chamber. In a preferred embodiment, the arrangement is done at a side or surface of the friction ring opposite the friction surface of the friction ring, to put it differently, at an inner surface. In preferred embodiments, the friction ring is formed round or circular. Alternatively preferably, also a waveform and/or a form, which is angular at least in a certain area, is conceivable. Here, the above-mentioned forms relate to a view substantially along the axis of rotation. Also in a view perpendicular to the axis of rotation several embodiments of the additional element are conceivable. It may be formed flatly and/or also angularly and/or sinuous. Preferably, it may alternatingly once rest against the one friction ring or the respective inner surface thereof and once rest against the other friction ring or the respective inner surface thereof.

In a preferred embodiment, at least one connecting web is formed as an additional element. Thus, advantageously, a plurality of additional non-load-bearing webs in the form of additional elements is attached between the friction rings. In this way, it is ensured that the brake disk remains functional even after the additional elements have failed due to corrosion. Alternatively preferably, it is also conceivable to apply an additional element over a large area or all-over, preferably on the inner surfaces of the brake disk.

Expediently, the additional element is in contact with a plurality of connecting webs. Here, in particular a wire-shaped material could be inserted as an additional element, which additional element is guided along between the connecting webs and is fixed within the brake disk by twisting, twirling or the like. Advantageously, such an embodiment may be attached to brake disks in particular also retroactively. Alternatively, the additional element may also run about the connecting webs tube-like from the inside towards the outside, in relation to the axis of rotation, which is particularly favorable for a method of manufacture, where the additional element is put into the casting mold already prior to casting on the friction ring. However, this variant is also very suitable for retroactively introducing the additional element. Basically, the additional element should be secured such that it can neither fall out nor noisily change its position, wherein the connecting webs allow for such securing by corresponding shaping of the additional element and a corresponding engagement (encompassing, bracing, and the like). To this end, it is decisive that the arrangement area is dimensioned and designed accordingly.

Preferably, a plurality of additional elements is provided. Thus, it is possible to very precisely control and selectively adapt the corrosion prevention. A manufacturer or user of brake disks knows as a rule from experience which points of a brake disk are critical with regard to corrosion. Said points are the connecting webs, for example. Advantageously, it is thus not necessary to provide the entire brake disk or the material of which the brake disk consists with an anti-corrosive coating, but only the connecting webs and/or the areas in the proximity of the connecting webs. By additional elements, which can be arranged retroactively, a highly individual corrosion protection can be realized since each user may attach the at least one additional element at the site, where he assumes a danger of corrosion.

Further preferably, the design of the additional element is such that a further function, preferably a cooling function, is provided. Advantageously, the additional element as an element encompassing the entire connecting web is designed such that it conducts the air selectively through the brake disk, similar to a turbine blade. Here, it has to be ensured that also when the additional element fails, a sufficient airflow is available for cooling the brake disk. As a matter of course, advantageously, a plurality of such additional elements providing a cooling function is provided.

Expediently, the additional element is designed or arranged or arrangeable at the connecting web and/or at the brake disk such that, when the brake disk rotates, an additional element released from the brake disk may not leave the intermediate chamber radially away from the axis of rotation and/or in the centrifugal direction. When seen from the axis of rotation, at first the additional element and then at a distance further away from the axis of rotation, but in the same direction as the additional element, the connecting web is arranged, for example. The latter, when seen radially to the axis of rotation, acts like a protective barrier or a protective wall. The departure direction of an additional element depends on the revolution speed of the brake disk so that it cannot be exactly predicted at which angle the additional element will fly away from the brake disk. Therefore, preferably, the protective barrier is made from several connecting webs, which are adapted to provide a barrier effect. Advantageously, a distance, when seen substantially perpendicular and substantially radial to the axis of rotation, measured between two connecting webs, is smaller than the additional element and/or the arrangement area thereof and/or the effective area thereof. When, for example, the effective area of an additional element has corroded through and, consequently, the additional element or the arrangement area would become released, it could not be thrown out, since it cannot pass the connecting webs or the space between two connecting webs. Preferably, a plurality of connecting webs act like a kind of labyrinth seal, however not for liquids or the like, but for additional elements, which fly away.

Advantageously, the additional element is connected to the brake disk in a form-fitting and/or force-fitting manner by means of a forming method. Preferably, the forming method is an internal high pressure forming method.

Preferably, the additional element or a plurality of additional elements is/are adapted and/or arranged such that the center of mass thereof can be or is arranged on the axis of rotation of the brake disk. As a matter of course, the center of mass of the brake disk is preferably arranged on the axis of rotation for a good true-running. Advantageously, the additional element is thus adapted or designed such that the center of mass thereof can be placed onto the axis of rotation. This is possible with disk-shaped, annular, i.e. substantially rotation-symmetric additional elements. Further preferably, a plurality of additional elements can be or is arranged relative to each other such that the common center of mass thereof can be arranged on the axis of rotation of the brake disk. I.e. it is only by arranging the additional elements relative to each other and finally on the brake disk, that the common center of mass of the additional elements is arranged on the axis of rotation. Preferably, at least two respective additional elements are arranged opposite the axis of rotation, radially seen, wherein seen in the circumferential direction two subsequent additional elements are always arranged at the same angle relative to each other, such as at an angle of 180°, 90° or 45°. To put it differently, they are preferably arranged at angles which, when multiplied with an integer multiple, give 360°. Preferably, the brake disk can also be balanced by means of the arrangement of the additional element(s), for example when the center of mass of the brake disk is not exactly on the axis of rotation. Preferably, the additional element is thus also a balancing weight.

According to the invention, an additional element, in particular a corrosion-inhibiting element, is adapted for being arranged, preferably in a form-fitting and/or force-fitting manner inside an intermediate chamber of a brake disk, in particular a vented brake disk. Thus, in particular, a retroactive arrangement of the additional element on the brake disk is preferred. Here, the word “retroactive” relates to the manufacture of the brake disk. Advantageously, the additional element can be arranged on the brake disk after the manufacturing process, i.e. retroactively. To this end, the additional element has at least one arrangement area, by means of which it can be arranged on a friction ring or on friction rings or at least on a connecting web etc.

According to the invention, an additional element, in particular a corrosion-inhibiting element, is adapted to be arranged at a brake disk by means of a forming method, preferably an internal high pressure forming method. Advantageously, in a preferred embodiment, the additional element is formed as an at least partially cylindrically formed hollow body, which is closed at one end. Preferably, the additional element is arranged in a receptacle, such as a corresponding opening or bore of the brake disk. The additional element arranged in the receptacle or in the opening is then expanded by means of an internal high pressure forming method such that its outer surface comes into a form-fitting and/or force-fitting connection with the brake disk. The expansion can preferably be done by means of a suitable hand tool, which expands the additional element by applying a force such that it is possible to produce a form-fit and/or force-fit with the brake disk. The additional element can be formed or designed differently. It is decisive that it provides for an opening such that it can be expanded, i.e. it has to have an access, such as at least one bore and/or at least an open side. The wall thicknesses can be formed differently, e.g. constant/not constant. When the internal pressure is the same, it is thus possible to realize different degrees of deformation and, thus, force fits and/or form fits with the surrounding material. Preferably, the additional element has a round, in particular a circular cross-section. The additional element can be or can alternatively be also be formed waved or polygonal (the corners can be connected by sinuous or straight lines etc.).

According to the invention, a method of manufacturing a brake disk, in particular for a commercial vehicle, comprises the following steps:
providing at least one additional element and a casting mold for a brake disk, in particular for a vented brake disk;
arranging the additional element in the casting mold;
casting the brake disk such that at least one arrangement area of the additional element is in contact with the brake disk, whereby at least in a certain area a form-fitting and/or force-fitting connection can be produced.
   Preferably, the arrangement area is cast around and/or cast-on at least in a certain area.

According to the invention, a method of manufacturing a brake disk, in particular for a commercial vehicle, comprises the following steps:
providing at least one additional element and a brake disk, in particular of a vented brake disk, wherein the brake disk has at least one receptacle for arranging the at least one additional element;
arranging the additional element in the receptacle of the brake disk;
producing a form-fitting and/or a force-fitting connection between the additional element and the brake disk by deforming the additional element by means of forming.
   Advantageously, the forming manufacturing method is an internal high pressure forming method.

According to the invention, a method of manufacturing a brake disk, in particular for a commercial vehicle, comprises the following steps:
providing at least one additional element and a brake disk, in particular of a vented brake disk;
arranging the additional element on the brake disk by means of a form-fitting and/or force-fitting connection.
   Advantageously, it is possible to retroactively provide any brake disk with the additional element using said method.

As a matter of course, the respective features of the brake disk according to the invention apply also to the additional elements according to the invention. The features of the brake disk according to the invention as well as of the additional elements according to the invention apply among each other as well as for the methods according to the invention.

Further advantages and features become apparent from the following description of preferred embodiments of the brake disk according to the invention, of the additional elements according to the invention, as well as of the methods according to the invention with references to the appended Figures. Individual features of the individual embodiments may be combined with each other within the scope of the invention.

### BRIEF DESCRIPTION OF THE DRAWINGS

The Figures show:

FIG. 1 shows a partial sectional view of a preferred embodiment of a brake disk approximately perpendicular to an axis of rotation;

FIG. 2 shows a sectional view of a preferred embodiment of a brake disk transverse to an axis of rotation;

FIG. 3a shows a sectional view of a preferred embodiment of a brake disk sectioned at the connecting webs with an annular additional element;

FIG. 3b shows a view of a preferred embodiment of a brake disk sectioned at the connecting webs with a substantially sinuous additional element;

FIG. 4a shows a partial sectional view of a preferred embodiment of a brake disk with an additional element taking over a cooling function;

FIG. 4b shows a partial sectional view of a preferred embodiment of a brake disk with additional elements formed as connecting webs;

FIG. 4c shows a partial sectional view of a preferred embodiment of a brake disk with two connecting webs connected by means of an additional element;

FIG. 4d shows a partial sectional view of a preferred embodiment of an additional element arranged in a form-fitting and/or force-fitting manner at two connecting webs;

FIG. 5a shows a sectional view of a preferred embodiment of an additional element;

FIG. 5b shows a preferred embodiment of an additional element arranged in a receptacle;

FIG. 5c shows a form-fitting and/or a force-fitting arrangement of the preferred embodiment of the additional element in the receptacle.

### DETAILED DESCRIPTION OF THE PREFERRED EMBODIMENTS

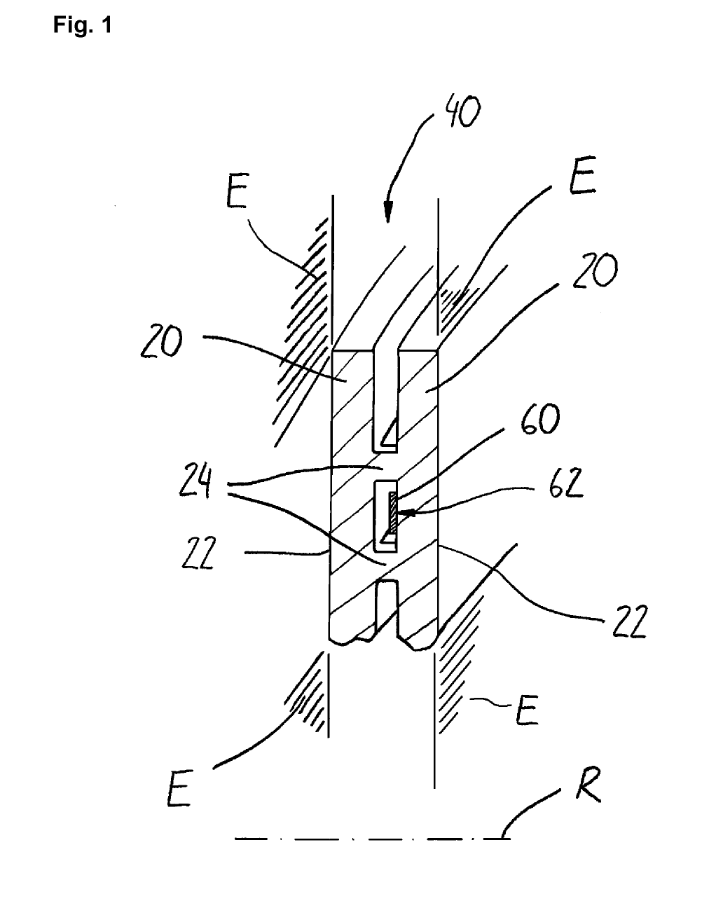

FIG. 1 shows a preferred embodiment of a brake disk in a sectional view substantially transverse to an axis of rotation R. The brake disk comprises two friction rings 20, each having a friction surface 22. Each of the two friction surfaces 22 describes a plane E. An intermediate chamber 40 forms between the planes E. The two friction rings 20 are connected by means of two connecting webs 24 in the section shown in FIG. 1. Between the two connecting webs 24, an additional element 60 is indicated, which is arranged by means of an arrangement area 62 at an inner surface of the right-hand friction ring 20, in the present case. The planes E as well as the entire brake disk are substantially perpendicular to an axis of rotation R.

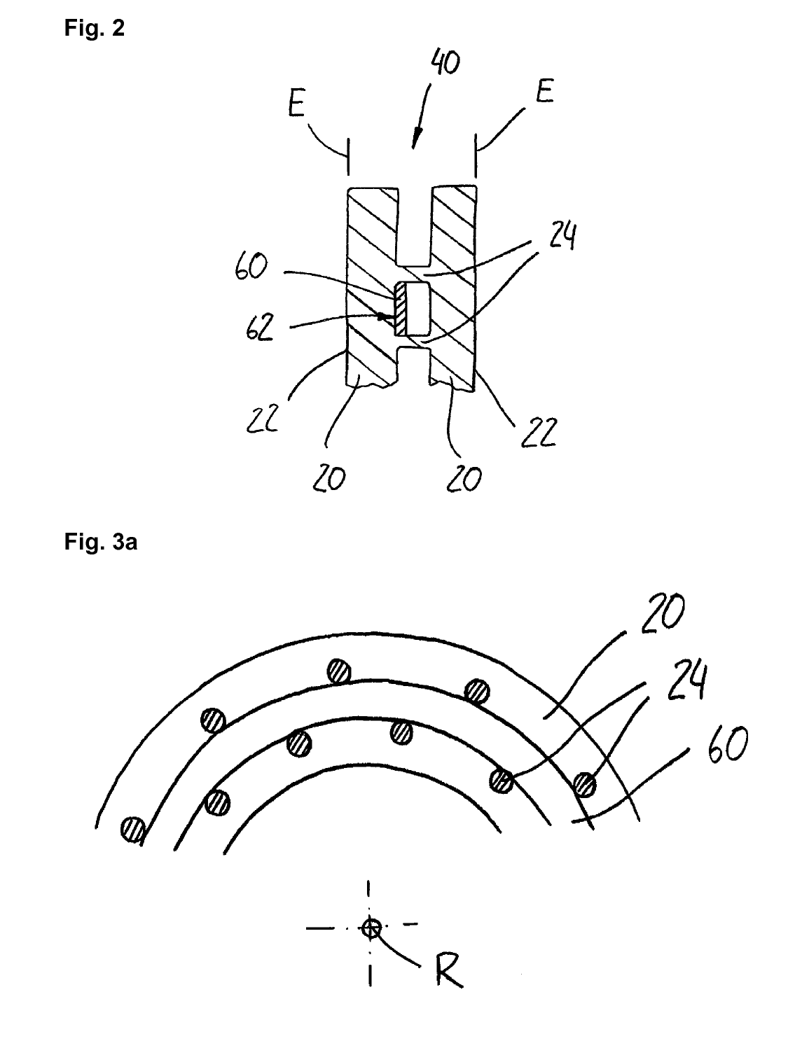

FIG. 2 shows a sectional view transverse to an axis of rotation R of a further preferred embodiment of a brake disk. There are shown two friction rings 20 with respective friction surfaces 22, at which the planes E extend. An intermediate chamber 40 forms between the planes E. Within the intermediate chamber 40, an additional element 60 with an arrangement area 62 is arranged on an inner surface of the left-hand friction ring, in the present case. It is also arranged directly at two connecting webs 24 connecting the two friction rings 20.

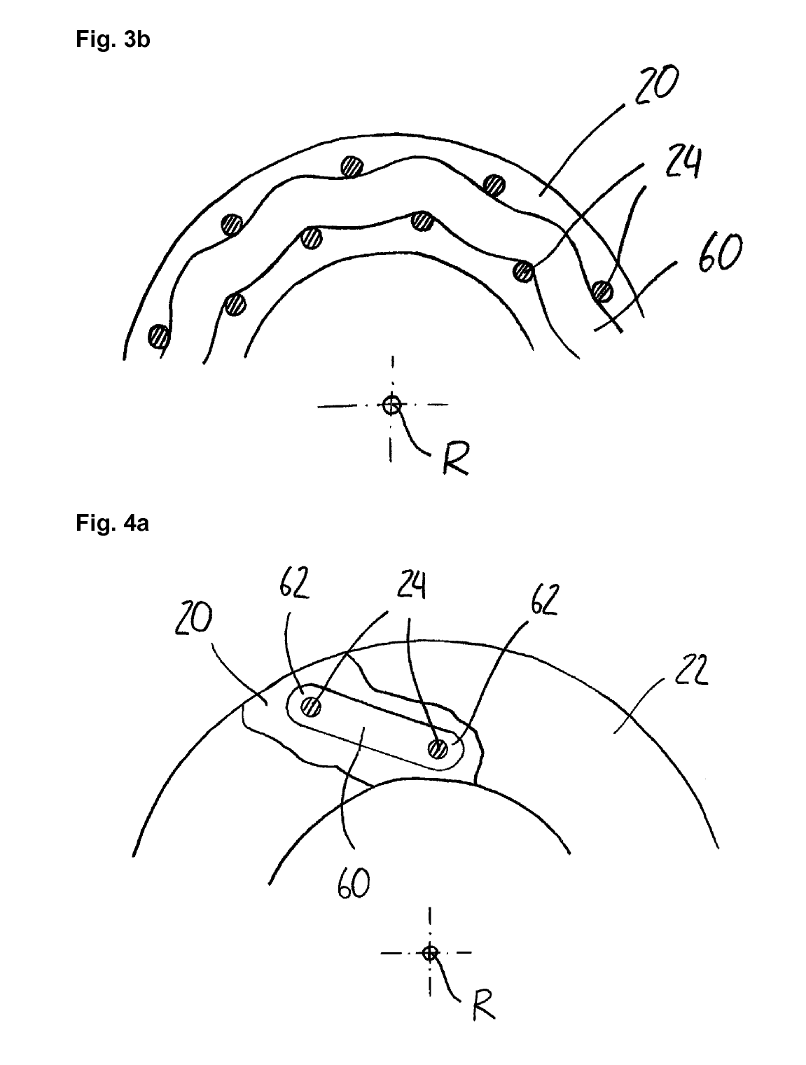

FIG. 3a shows a preferred embodiment of a brake disk in a sectional view sectioned transverse to an axis of rotation R. There is shown a friction ring 20 with a plurality of connecting webs 24, which are shown as shaded areas in FIG. 3a. Between and along the connecting webs 24 an additional element 60 runs, which is substantially concentric about an axis of rotation R.

FIG. 3b shows a further preferred embodiment of a brake disk with a substantially sinuous additional element 60. FIG. 3b further shows a friction ring 20 with a plurality of connecting webs 24, about which the additional element 60 winds. The entire arrangement of the friction ring 20, the connecting webs 24 and the additional element 60 is positioned substantially perpendicular to an axis of rotation R.

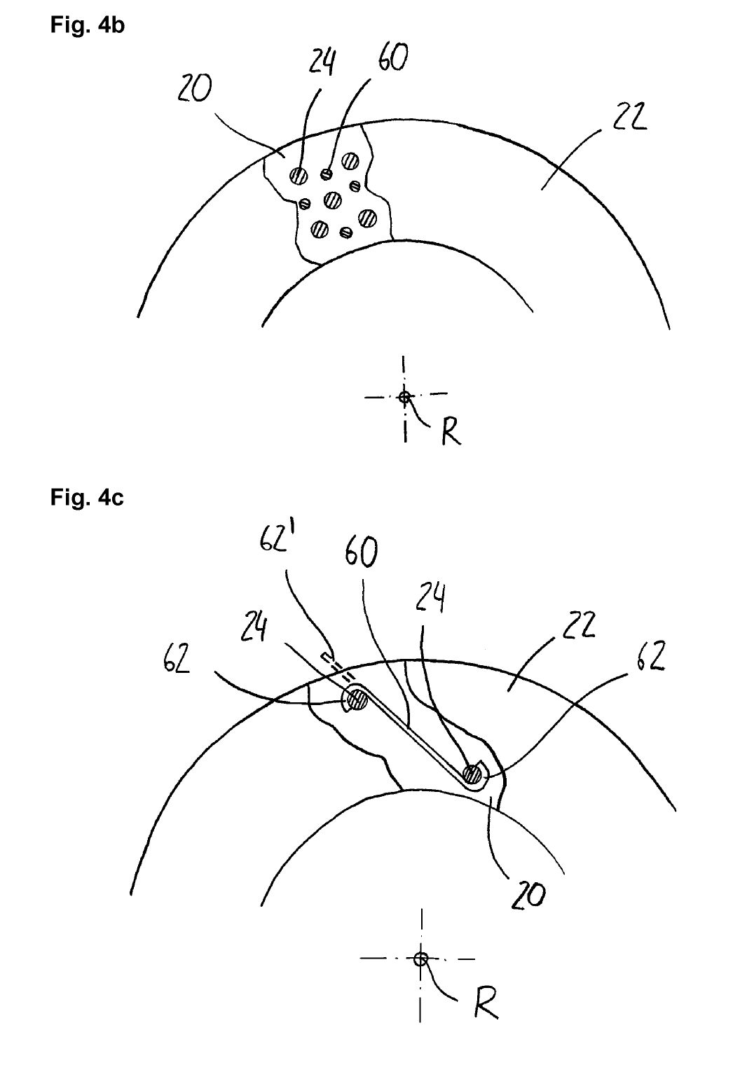

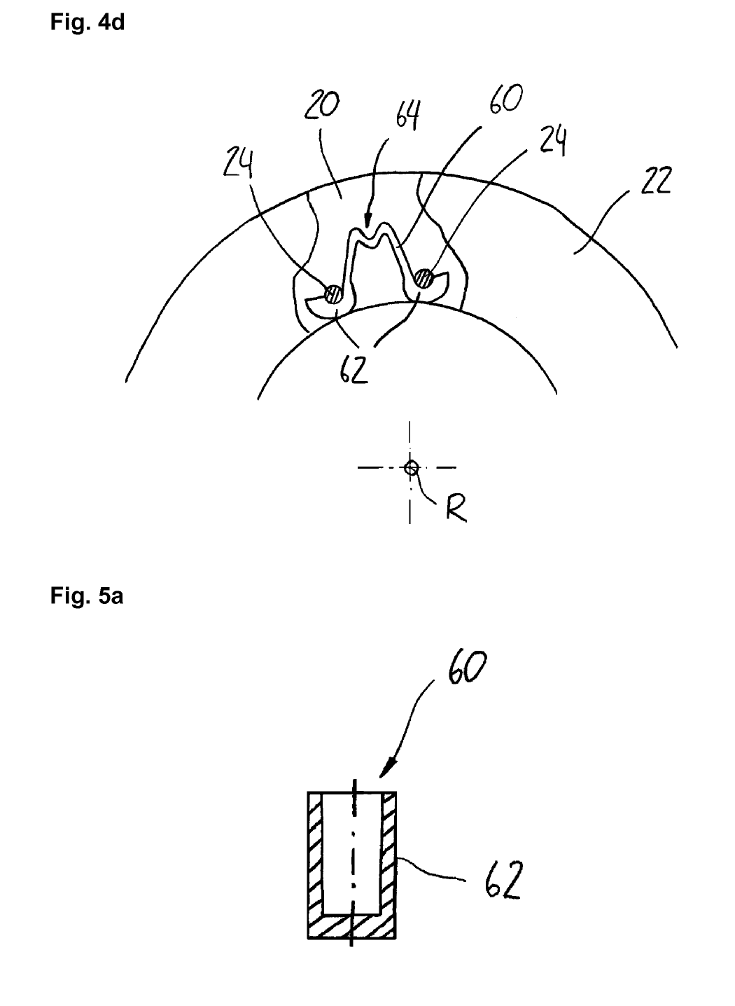

FIG. 4a shows a further preferred embodiment of a brake disk in a partially sectional view. There is shown a friction surface 22 and a friction ring 20, which lies behind it in a direction seen in the direction of rotation R. In the preferred embodiment shown in FIG. 4a, an additional element 60 connected by means of two arrangement areas 62 to two respective connecting webs 24 fulfills a cooling function due to a blade configuration.

FIG. 4b shows a preferred embodiment of a brake disk in a partially sectional view. FIG. 4b shows a friction surface 22 and a friction ring 20. The preferred embodiment of the brake disk has additional elements 60 having substantially the form of connecting webs 24.

FIG. 4c shows a further preferred embodiment of a brake disk in a partially sectional view. There is shown a brake surface 22 and a friction ring 20, which lies behind it. An additional element 60 is arranged in a form-fitting and/or force-fitting manner about two connecting webs 24 by means of two arrangement areas 62. The upper one of the two arrangement areas 62 is shown in dashed lines in a basic state 62′. This means that in the preferred embodiment of the additional element 60 shown in FIG. 4c, the arrangement area is designed deformably such that it can be adjusted to or arranged at the connecting web 24 by hand, for example.

FIG. 4d shows a partially sectional view of a further preferred embodiment of a brake disk. An additional element 60 has two arrangement areas 62, by means of which the additional element 60 is arranged at two connecting webs 64 in a form-fitting and/or force-fitting manner. The two arrangement areas 62 are connected to one another by means of an effective area 64. While the two arrangement areas 62 are thick and provided with a comparatively small surface, the effective area 64 between them is thin and provided with a large surface. In addition, by means of the effective area 64 or the form thereof, an at least partial bracing of the additional element 60 between the connecting webs 24 is achieved. Thus, it is easily conceivable that, in the position of the brake disk shown in FIG. 4d, the remaining parts of the additional element 60 fall in the direction of an axis of rotation R or towards the bottom, following the force of gravity, for example, when the effective area 64 dissolves. It is further a matter of course that the additional element 60 as it is shown in FIG. 4d can be easily re-mounted, by clipping it into the brake disk from the inside, for example.

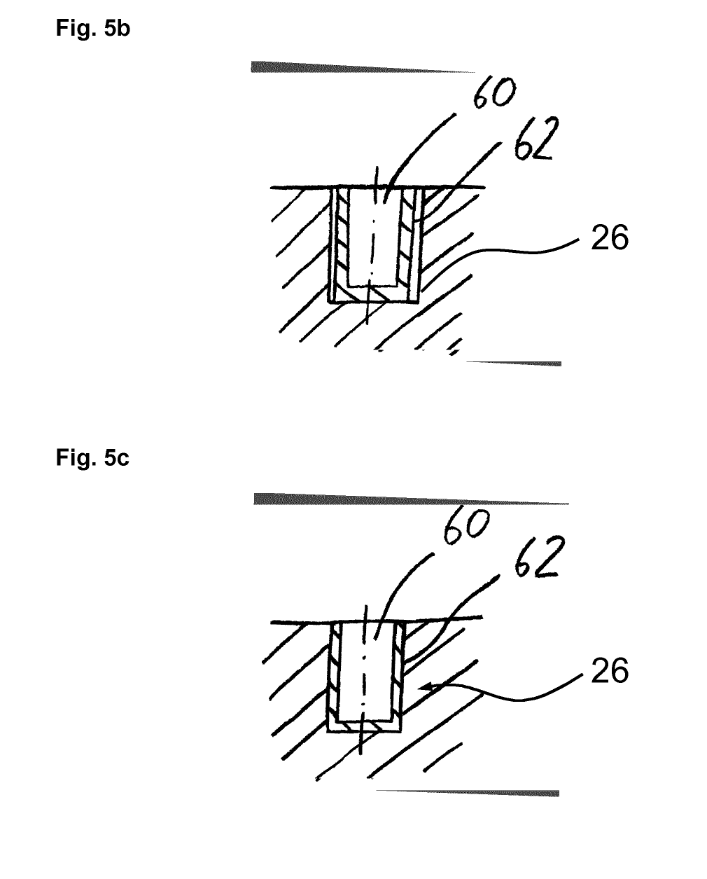

FIG. 5a shows a preferred embodiment of an additional element. The additional element 60 is formed as a substantially cylindrical hollow body, which is closed at one end. It can be arranged on a further element such as a brake disk by means of an arrangement area 62.

FIG. 5b shows a preferred embodiment of an additional element 60 with an arrangement area 62 in a loose arrangement within a further element. The further element may be a friction ring 20 or a connecting web 24 of a brake disk, for example. The further element, in particular the connecting web 24 or the brake disk, has a receptacle 26 for arranging it, which receptacle is a bore in the preferred embodiment shown in FIG. 5b.

FIG. 5c shows the embodiment of the additional element 60 known from FIG. 5b, which is connected to the receptacle 26 of the further element, such as the connecting web or the brake disk, in the state shown in FIG. 5c in a form-fitting and/or force-fitting manner. The connection is achieved by means of at least partially circumferentially expanding the additional element 60 and, thus, the arrangement area 62 thereof, preferably by a forming manufacturing method such as internal high pressure forming. Alternatively preferably, however, such small components can also by arranged manually with a correspondingly adapted “expanding” tool.

### LIST OF REFERENCE SIGNS

20 friction ring
22 friction surface
24 connecting web
26 receptacle
40 intermediate chamber
60 additional element
62 arrangement area
62′ arrangement area in a basic state
64 effective area
E plane
R axis of rotation

1.-15. (canceled)

16. A brake disk, for a commercial vehicle, comprising:
two friction rings that are arranged substantially parallel to each other; and
at least one connecting web;
wherein the friction rings each have a friction surface each defining a plane;
wherein the at least one connecting web connects the two friction rings to each other such that an intermediate chamber is located between the planes of the friction rings;
wherein the intermediate chamber extends from one friction ring to the other friction ring;
wherein the brake disk has at least one additional element that is arranged inside the intermediate chamber; and
wherein the additional element comprises a material baser than the at least one connecting web and the friction rings.

17. The brake disk of claim 16, wherein the additional element has an arrangement area fixable to at least one of the connecting web and at least one friction ring.

18. The brake disk of claim 17, wherein the additional element has an effective area weakenable by corrosion such that the arrangement of the additional element is releasable from the brake disk by corrosion of the effective area.

19. The brake disk of claim 18, wherein the additional element comprises a ring that at least in a certain area runs about an axis of rotation of the brake disk.

20. The brake disk of claim 19, wherein at least one connecting web comprises a separate element.

21. The brake disk of claim 20, wherein the additional element is in contact with a plurality of the connecting webs.

22. The brake disk of claim 21, wherein a plurality of additional elements is adapted to provide a cooling function.

23. The brake disk of claim 22, wherein the additional element is at least one of configured and arranged on at least one of the connecting web and the brake disk such that, when the brake disk rotates, the additional element released from the brake disk may not leave the intermediate chamber radially away from at least one of the axis of rotation and the centrifugal direction.

24. The brake disk of claim 23, wherein the additional element is connected to the brake disk in at least one of a form-fitting and force-fitting manner by a forming manufacturing method.

25. The brake disk of claim 24, wherein the additional element is adapted to be arranged such that the center of mass of the additional element is arranged on the axis of rotation of the brake disk.

26. The brake disk of claim 16, wherein the additional element has an effective area weakenable by corrosion such that the arrangement of the additional element is releasable from the brake disk by corrosion of the effective area.

27. The brake disk of claim 16, wherein the additional element comprises a ring that at least in a certain area runs about an axis of rotation of the brake disk.

28. The brake disk of claim 16, wherein at least one connecting web comprises a separate element.

29. The brake disk of claim 16, wherein the additional element is in contact with a plurality of the connecting webs.

30. The brake disk of claim 16, wherein a plurality of additional elements is adapted to provide a cooling function.

31. The brake disk of claim 16, wherein the additional element is at least one of configured and arranged on at least one of the connecting web and the brake disk such that, when the brake disk rotates, the additional element released from the brake disk may not leave the intermediate chamber radially away from at least one of the axis of rotation and the centrifugal direction.

32. The brake disk of claim 16, wherein the additional element is connected to the brake disk in at least one of a form-fitting and force-fitting manner by a forming manufacturing method.

33. The brake disk of claim 16, wherein the additional element is adapted to be arranged such that the center of mass of the additional element is arranged on the axis of rotation of the brake disk.

34. An additional element for preventing corrosion within a brake disk, wherein the additional element is adapted for being arranged in at least one of a form-fitting and force-fitting manner, inside an intermediate chamber of a vented brake disk, wherein the intermediate chamber extends from one friction ring to another friction ring of the brake disk, and wherein the additional element comprises a material that prevents corrosion of the brake disk.

35. An additional element for preventing corrosion within a brake disk, wherein the additional element is adapted to be arranged in an intermediate chamber of a brake disk by an internal high pressure forming method, wherein the intermediate chamber extends from one friction ring to the other friction ring, and wherein the additional element comprises a material that prevents corrosion of the brake disk.

36. A method of manufacturing a brake disk, wherein the brake disk includes two substantially parallel friction rings and at least one connecting web, the method comprising:
providing at least one additional element and a vented brake disk;
arranging the additional element in the casting mold; and
casting the brake disk such that at least one arrangement area of the additional element is in contact with the brake disk, whereby at least in a certain area at least one of a form-fitting and force-fitting connection is produced, wherein the additional element is arranged within an intermediate chamber that extends from one friction ring to the other friction ring; and
wherein the additional element comprises a material baser than the at least one connecting web and the friction rings.

37. A method of manufacturing a brake disk, wherein the brake disk includes two substantially parallel friction rings and at least one connecting web, the method comprising:
providing at least one additional element and a vented brake disk, wherein the brake disk has at least one receptacle for arranging the at least one additional element;
arranging the additional element in the receptacle of the brake disk; and
producing at least one of a form-fitting and a force-fitting connection between the additional element and the brake disk by at least one of deforming and shaping the additional element, wherein the additional element is arranged within an intermediate chamber that extends from one friction ring to the other friction ring; and
wherein the additional element comprises a material baser than the at least one connecting web and the friction rings.

38. A method of manufacturing a brake disk, wherein the brake disk includes two substantially parallel friction rings and at least one connecting web, the method comprising:
providing at least one additional element and a vented brake disk; and
arranging the additional element within an intermediate chamber on the brake disk by at least one of a form-fitting and force-fitting connection, wherein the intermediate chamber extends from one friction ring to the other friction ring; and
wherein the additional element comprises a material baser than the at least one connecting web and the friction rings.
